(19) United States
(12) Patent Application Publication
(10) Pub. No.: US 2010/0084249 A1
(43) Pub. Date: Apr. 8, 2010

(54) SNAP-ON, PUSH BUTTON, ROTARY MAGNETIC ENCODER KNOB ASSEMBLY

(75) Inventors: Gregory S. Bandy, Roanoke, VA (US); Charles D. Willey, Roanoke, VA (US)

Correspondence Address: RATNERPRESTIA, P.O. BOX 980, VALLEY FORGE, PA, 19482, US

(73) Assignee: ITT MANUFACTURING ENTERPRISES, INC., WILMINGTON, DE (US)

(21) Appl. No.: 12/246,743

(22) Filed: Oct. 7, 2008

(51) Int. Cl. H01H 9/00

(52) U.S. Cl. 200/4

(57) ABSTRACT

The present invention includes a push button rotary knob assembly which provides rotational movement and translational travel along an axis. The present invention controls electronics within a housing, without requiring protrusion into the housing. Having no protrusions into the housing avoids exposure of the electronics within the housing to environmental contaminants or electromagnetic interference. The components of the push button rotary knob assembly may operate without need for O-rings, gaskets, or any other applied sealants. Assembly of the push button rotary knob is simplified, because the rotary knob may be assembled and replaced without any tools and without need to access the interior of the housing. Furthermore, if the rotary knob is damaged, the rotary knob may be replaced, and any seal provided to exterior surfaces of the housing is not compromised.

### FIELD OF THE INVENTION

The present invention relates, in general, to a knob assembly. More specifically, the present invention relates to a push button rotary knob assembly which provides contactless control of an electronic device residing in a housing, without direct physical contact with the interior of the housing.

### BACKGROUND OF THE INVENTION

In many electronic housings, in which space is at a premium, control functions are often consolidated in a single control knob. For example, a rotary knob which has several rotational positions for activating several electronic functions may be combined with a push button switch, which may have only one function for turning the electronics on/off. While enabling multiple control functions of the electronics in the housing, the rotary-push button control knob complicates the assembly of the housing and makes replacement of the control knob difficult.

An control knob of this type typically requires protrusion into the housing of the electronics, in order to transmit the various controls to the electronics. The protrusion creates an opening into the housing which may allow environmental contamination and electromagnetic interference (EMI) into the electronics.

To mitigate the risks associated with environmental contamination and EMI, operator control knobs of this type have utilized O-rings, gaskets, or other applied sealants. This, in turn, may be messy and may further complicate the assembly or maintenance of the control knob. Furthermore, because the control knob requires a protruding member to be inserted into the housing, the protruding member occupies a portion of the internal volume of the housing which may be better used for other purposes.

As will be explained, the present invention provides a rotary knob assembly that has advantages over conventional rotary knob assemblies, because the rotary knob assembly of the present invention does not require any intrusion into the housing, nor direct contact with the internal electronics of the housing. As will be described, the present invention provides a push button rotary knob assembly which contactlessly controls an electronic device, without protrusion into the housing of the electronics and without direct contact with the electronics.

### SUMMARY OF THE INVENTION

To meet this and other needs, and in view of its purposes, the present invention provides a push button rotary knob assembly including an encoder disposed internally within a housing and a rotary knob disposed externally to the housing. A boundary surface of the housing is interposed between the encoder and the rotary knob and physically isolates the interior of the housing from the rotary knob. The boundary surface prevents environmental leakage and electromagnetic interference from entering the housing. The encoder is configured to decode the angular orientation of the rotary knob and transmit a corresponding control function to the electronics within the housing.

Another embodiment of the present invention provides an operator control unit including a push button rotary knob assembly. The push button rotary knob assembly includes an encoder disposed internally within a housing and a rotary knob disposed externally to the housing. The rotary knob provides rotational movement to the operator control unit. A push button is disposed within the rotary knob, providing axial translation of the push button. The push button may be depressed independently of any rotational movement to the rotary knob. A boundary surface of the housing is interposed between the encoder and the rotary knob and physically isolates the interior of the housing from the rotary knob. The boundary surface prevents environmental leakage and electromagnetic interference from entering the housing. The encoder is configured to decode the angular orientation of the rotary knob and the axial translation of the push button.

Furthermore, the present invention includes a method of controlling an electronic device disposed within a housing. The electronic device may be controlled by the steps of: (a) depressing a rotary knob disposed externally to the housing, (b) axially rotating the rotary knob, and (c) contactlessly communicating the translational and rotational positions of the rotary knob to an encoder disposed internally within the housing, without any physical contact between the rotary knob and the encoder. The encoder then decodes the translational and rotational positions of the rotary knob and transmits at least one control function to the electronic device.

It is understood that the foregoing general description and the following detailed description are exemplary, but are not restrictive, of the invention.

### BRIEF DESCRIPTION OF THE DRAWINGS

The invention is best understood from the following detailed description when read in connection with the accompanying drawings. Included in the drawings are the following figures:

FIG. 1 shows a cross-section of a rotary knob assembly, in accordance with an embodiment of the present invention;

FIG. 2 is an exploded view of the rotary knob assembly shown in FIG. 1;

FIG. 3 is a perspective view of the rotary knob assembly of FIG. 1, taken along line 3-3;

FIG. 4 is a cross-sectional view of an embodiment of the present invention, including an encoder operating with the rotary knob assembly shown in FIG. 1;

### DETAILED DESCRIPTION OF THE INVENTION

The present invention includes a push button rotary knob assembly. As will be explained, the knob assembly provides rotational movement and translational travel along an axis. Unlike conventional knobs and switches, the present invention controls electronics within a housing, without requiring protrusion into the housing. The components of the present invention may operate without need for O-rings, gaskets, or any other applied sealants.

The push button rotary knob assembly of the present invention offers many advantages, because no portion of the rotary knob protrudes through the housing. For example, (1) there is no leakage path into the housing where environmental contamination or electromagnetic interference (EMI) may enter; (2) the internal volume of the housing, which is dedicated as an interface to the rotary knob, is much smaller than the internal volume required by a conventional rotary knob with the same control functions; (3) a large boss on the housing may be used to guide the rotation of the rotary knob, because the boss does not have to intrude into the housing; and (4) no messy sealants or adhesives are necessary to seal the rotary knob and any housing interface to the rotary knob.

In addition, conventional knobs and switches require multiple steps and tools to assemble the components of the switch assembly. The push button rotary knob assembly of the present invention, on the other hand, simplifies the assembly process. For example, (1) the rotary knob may be assembled and replaced without any tools; and (2) the rotary knob may be assembled and replaced without need to access the interior of the housing, thereby avoiding exposure of the internal components of the housing to environmental contaminants or electromagnetic interference. Furthermore, should the rotary knob be damaged, the housing seal is not compromised. These and other benefits may be understood by referring to the following description together with the figures.

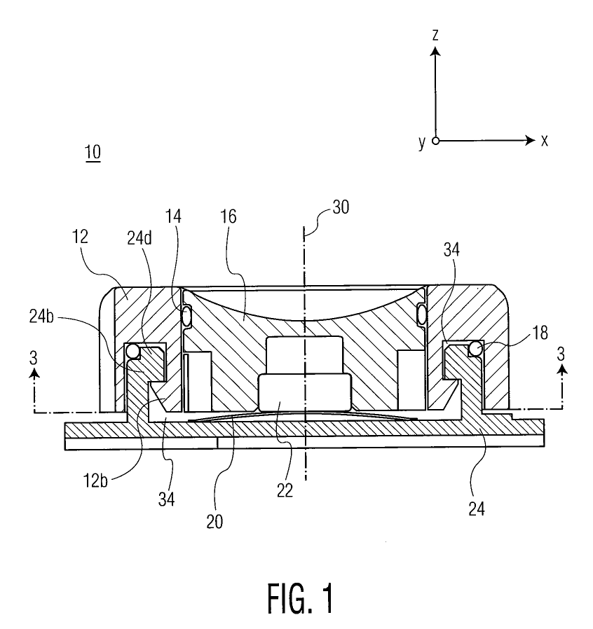

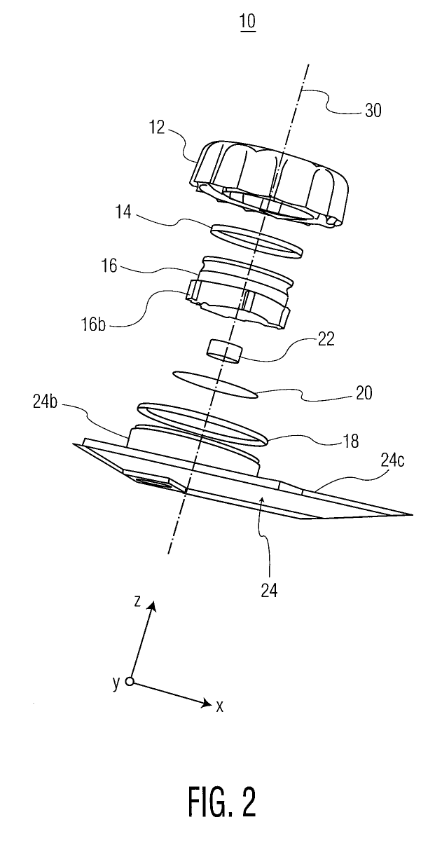

Referring first to FIGS. 1 and 2, there is shown an embodiment of the present invention. As shown, a push button rotary knob assembly, generally designated as 10, includes rotary knob 12 and push button 16, which interface with housing boss 24b of housing 24. A magnet 22 is inserted into a central bore in push button 16, on the side of the push button adjacent to external boundary surface 24c of housing 24.

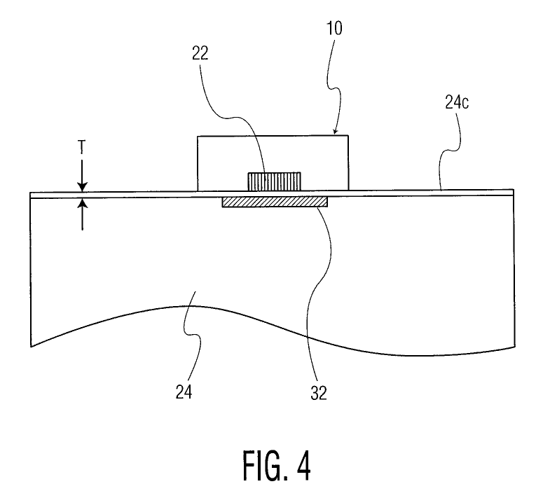

The rotational and translational positions of magnet 22 are read by encoder 32, disposed internally to housing 24 (shown in FIG. 4). As will be described, magnet 22 and encoder 32, together serving as an operator control unit, communicate through boundary surface 24c, thereby providing user control of the various modes and functions for operating the electronics within housing 24.

A snap dome 20 resides between push button 16 and external boundary surface 24c. The snap dome 20 is positioned with its central portion curved away from the housing in order to bias push button 16 away from external boundary surface 24c.

The O-rings 14 and 18 are optional in the present invention, but may be included to seal the rotary knob assembly and keep particulates from building up within the interior of rotary knob assembly 10.

The push button rotary knob assembly 10 engages housing 24 at housing boss 24b, as shown in FIG. 1, without intruding into the interior of housing 24. The rotary knob 12 includes snap retention features 12b within circumferential slot 34. The housing boss 24b includes locking extension 24d. The circumferential slot 34 receives housing boss 24b, where the latter is held in place by snap retention features 12b. The snap retention features interlock with locking extension 24d of housing boss 24b. The snap retention features 12b grasp housing boss 24b at an inner diameter face of housing boss 24b, while rotary knob 12 surrounds the outer diameter face of housing boss 24b. This manner of attachment of push button rotary knob assembly 10 to housing 24 allows for easy assembly and replacement, and eliminates any need for intrusion or opening into the interior of the housing.

In operation, the push button rotary knob assembly includes rotational movement about z-axis 30 and translational travel along z-axis 30. The push button 16, which is inserted within the rotary knob, may be depressed along z-axis 30 toward housing 24, independently of any rotational movement to knob 12. The spring-like bias of snap dome 20 provides tactile feedback to a user upon depressing the push button to activate the electronics within the housing. The snap dome 20 springs back, forcing the push button to also spring back, when depression of the push button is stopped.

The angular and translational positions of magnet 22 with respect to z-axis 30 may be changed by sequentially depressing, rotating and releasing rotary knob 12. This change may be decoded, or interpreted by encoder 32 (FIG. 4) which is disposed on the other side of housing surface 24c. As one example, rotary knob 12 may be depressed and rotated around z-axis 30 by an angle Θ. The angle Θ may be determined by encoder 32 as the user wanting to activate function A (for example). In turn, encoder 32 may activate function A for the electronics within housing 24. As another example, a control function may be activated by simply depressing and releasing the rotary knob and/or the push button. Upon depression and release, the encoder may detect a change in magnetic intensity, as the rotary knob is momentarily moved closer to encoder 32.

FIG. 2 shows an exploded view of push button rotary knob assembly 10 and portions of housing 24. As shown, magnet 22 may be inserted into a bore of push button 16. The latter, which includes circumferentially arranged keys 16b may then be inserted into circumferentially arranged mating slots 12c of rotary knob 12. The insertion may be accomplished from the side of rotary knob 12 that is closest to housing 24.

The snap dome 20 may be placed within a core of housing boss 24b beneath magnet 22 and push button 16 (FIG. 1). As already described, snap dome 20 provides tactile feedback for the user when push button 16 is depressed. The O-rings 14 and 18 are also shown in FIG. 2, but are not necessary to the present invention.

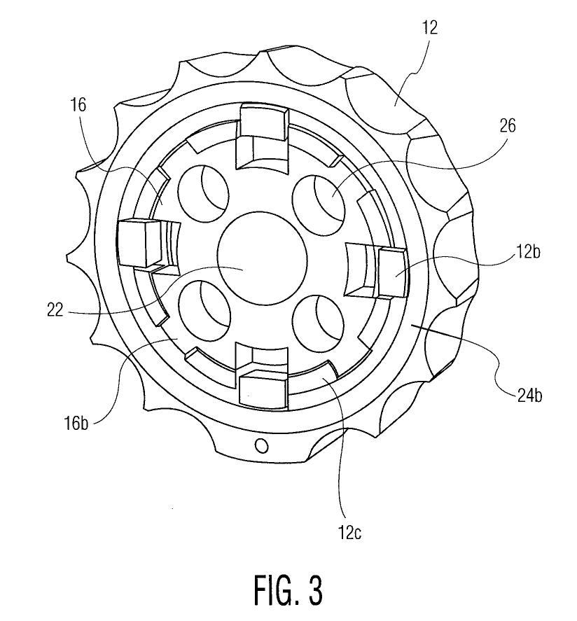

FIG. 3 is a perspective view, taken along line 3-3, of push button rotary knob assembly 10 shown in FIG. 1. Keys 16b of push button 16 and mating slots 12c of rotary knob 12, when aligned and engaged, permit the user to turn magnet 22 by turning rotary knob 12. Keys 16b of push button 16 and mating slots 12c of rotary knob 12, when aligned and engaged, also act as a guide for axial translation along z-axis 30.

FIG. 4 is a cross-sectional view of an embodiment of the present invention showing the relationship between encoder 32 and push button rotary knob assembly 10, the latter including magnet 22. The encoder 32 is disposed entirely within housing 24 and is separated from push button rotary knob assembly 10 by boundary surface 24c. The rotational and translational positions of magnet 22 are magnetically sensed by encoder 32 without any direct contact. This provides contactless communication between the magnet and the encoder.

Because of its contactless communication capability, the rotary knob assembly 10 is ideally suited for harsh environments. It is reliable and immune from adverse environmental conditions, such as dust, moisture, vibration and electromagnetic interference. The magnet 22 and encoder 32 may be separated across boundary surface 24c by a thickness T varying between 0.5-1.8 mm (for example).

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A knob assembly comprising
an encoder disposed internally within a housing,
a rotary knob disposed externally to the housing, wherein an angular orientation of the rotary knob is decoded by the encoder as a control function, and
a boundary surface of the housing is interposed between the encoder and the rotary knob for preventing environmental leakage and electrical interference paths into the housing,
wherein the encoder is configured to decode the angular orientation of the rotary knob, and
the boundary surface physically isolates the interior of the housing from the rotary knob.

2. The knob assembly of claim 1 wherein
the encoder is configured to decode an axial translation of the rotary knob as another control function.

3. The knob assembly of claim 1 wherein
the boundary surface is free-of any physical openings for providing electrical conductors between the rotary knob and the encoder.

4. The knob assembly of claim 1 wherein
the boundary surface is free-of any physical openings for providing physical elements of the rotary knob into the interior of the housing.

5. The knob assembly of claim 1 wherein
the rotary knob includes a magnet, and
the encoder is configured to decode an angular rotation of the magnet as a control function.

6. The knob assembly of claim 1 wherein
the rotary knob includes a magnet, and
the encoder is configured to decode an axial translation of the magnet as a control function.

7. The knob assembly of claim 6 wherein
the rotary knob includes a push button,
the magnet is inserted within the push button, and
the push button axially translates the magnet to activate a control function.

8. The knob assembly of claim 7 wherein
the push button includes a cylindrical wall having protruding keys arranged circumferentially about the cylindrical wall,
the rotary knob includes mating slots for receiving the protruding keys, and
when the keys are received in the mating slots and the rotary knob is rotated, the magnet is rotated.

9. The knob assembly of claim 1 wherein
the housing includes a cylindrical projection extending from the boundary surface for providing a boss for the rotary knob.

10. The knob assembly of claim 9 wherein
the rotary knob includes snap retention features within a circumferential slot,
the boss includes a locking extension, and
the locking extension interlocks with the snap retention features within the circumferential slot.

11. The knob assembly of claim 1 wherein
the rotary knob includes a tactile feedback mechanism,
the tactile feedback mechanism is sandwiched between the rotary knob and the boundary surface of the housing, and
the tactile feedback mechanism provides user feedback, when the rotary knob is axially translated.

12. The knob assembly of claim 11 wherein
the tactile feedback mechanism includes a snap dome.

13. An operator control unit including a push button rotary knob assembly, comprising:
an encoder disposed internally within a housing,
a rotary knob disposed externally to the housing, wherein an angular rotation through an angle of Θ is decoded by the encoder as a control function,
a push button disposed within the rotary knob for providing axial translation of the rotary knob, and
a boundary surface of the housing interposed between the encoder and the rotary knob for preventing environmental leakage and electrical interference paths into the housing,
wherein the encoder is configured to decode the angular orientation and the axial translation of the rotary knob, and
the boundary surface physically isolates the interior of the housing from the rotary knob.

14. The operator control unit of claim 13, wherein
a magnet is disposed in the push button, and
the encoder decodes the angular orientation and the axial translation of the magnet, free-of any electrical conductors.

15. The operator control unit of claim 13, wherein
the push button includes a cylindrical wall having protruding keys arranged circumferentially about the cylindrical wall,
the rotary knob includes mating slots for receiving the protruding keys, and
when the protruding keys are received in the mating slots and the rotary knob is rotated, the magnet is rotated.

16. The operator control unit of claim 13 wherein
the housing includes a cylindrical projection extending from the boundary surface and providing a boss for the rotary knob.

17. The operator control unit of claim 16 wherein
the rotary knob includes snap retention features within a circumferential slot,
the boss includes a locking extension extending from the cylindrical projection, and
the locking extension interlocks with the snap retention features within the circumferential slot.

18. A method of controlling an electronic device disposed within a housing, comprising the steps of:
depressing a rotary knob disposed externally to the housing;
axially rotating the rotary knob;
contactlessly communicating translational and rotational positions of the rotary knob to an encoder, disposed internally within the housing, without any physical contact between the rotary knob and the encoder;
decoding, by the encoder, the translational and rotational positions of the rotary knob; and
activating a control function of the electronic device, in response to the decoding step.

19. The method of controlling an electronic device of claim 18 wherein
a magnet is disposed in the rotary knob, and
the magnet contactlessly communicates the translational and rotational positions of the rotary knob.

20. The method of controlling an electronic device of claim 18 wherein
depressing the rotary knob biases a tactile feedback mechanism sandwiched between the rotary knob and the housing, and
provides feedback to a user.
